(19) United States
(12) Patent Application Publication
(10) Pub. No.: US 2015/0354132 A1
(43) Pub. Date: Dec. 10, 2015

(54) CURING METHODS AND PRODUCTS PRODUCED THEREFROM

(71) Applicant: ARMSTRONG WORLD INDUSTRIES, INC, Lancaster, PA (US)

(72) Inventors: ELKE SCHWEERS, Schwanewede (DE); JENS EHLERS, Hamminkeln (DE); OLIVER REICHEL, Bremen (DE); REINER MEHNERT, Markkleeberg (DE); JOSHUA J. LENSBOUER, Mount Joy, PA (US); DONG TIAN, Lancaster, PA (US)

(21) Appl. No.: 14/760,080

(22) PCT Filed: Jan. 17, 2014
(86) PCT No.: PCT/US14/12010

§ 371 Date: Jul. 9, 2015

Related U.S. Application Data
(60) Provisional application No. 61/753,807, filed on Jan. 17, 2013.
(60) Provisional application No. 61/753,813, filed on Jan. 17, 2013.

(51) Int. Cl. D06N 1/00; D06N 7/00; B05D 3/06

(52) U.S. Cl. CPC D06N 1/00; B05D 3/067; D06N 7/00; D06N 2205/20; D06N 2211/063; D06N 2211/066

(57) ABSTRACT

Described herein are low-emission sheet materials, comprising at least one base layer and a (meth)acrylate-based coating arranged thereon, wherein the sheet material has a TVOC (total volatile organic compounds) value of ≦50 μg/m².h, measured according to ISO 16000-10 by means of a field and laboratory emission cell (FLEC). Also described herein, are methods for making and using wear layers and sheet materials comprising same, obtained by irradiation at a wavelength from 10 nm to 200 nm or by irradiation wing a source of high-energy photons in combination with a UV radiator.

### CROSS-REFERENCE TO RELATED PATENT APPLICATIONS

This application claims priority to U.S. Provisional Patent Application Ser. No. 61/753,807, filed Jan. 17, 2013, and U.S. Provisional Patent Application Ser. No. 61/753,813, filed Jan. 17, 2013, the entireties of which are hereby incorporated herein by

reference in their entireties.

### BACKGROUND

The present invention concerns a low-emission sheet material, a method for production of the sheet material of the invention, and the use of the sheet material according to the invention.

In recent time flooring of the most diverse materials of varying quality and properties is being used for interior furnishings, the spectrum running the gamut from wood floors with sealed or unsealed surface, laminate, synthetic, linoleum and cork flooring, tiles and stone floors, even to textile floor coverings that are either glued, loose or tensioned. The most diverse demands are placed on the different materials, such as good strength, resistance to various materials, but also easy upkeep. For this, the various flooring materials are often provided with a top or protective layer, which should also improve the desired properties.

For example, for decades multilayered synthetic webs based on polyvinyl (PVC) with a transparent top layer as the wearing surface have bees used as flooring. A multilayered synthetic web or sheet that is used as flooring consists of at least two layers, a transparent top layer or wearing surface (also called a clear layer or clear film) and a lower or base layer (also called the lower film), while often a further (intermediate) layer can be arranged in between, being termed a print film, white film, printed film, decorative film, print substrate or printed white film.

Such protective layers or protective films are also used on surface structures based on linoleum or korkment, which has been employed for many years particularly as flooring, and in this way the abrasion of linoleum or korkment flooring can be reduced, for example. However, these films are often made from nonrenewable materials.

Due to the fact that floorings are usually laid over a large area indoors, they can be a significant source of emissions indoors. Besides functional and decorative aspects, therefore, environment and health protection standpoints are playing an increasing role in recent time.

It is known that, besides the materials of the additionally incorporated layers, the particular base materials also can constitute a possible emission source. Even flooring based on renewable raw materials that are basically ecologically harmless, such as linoleum, has harmful emissions, and substances such as aldehydes, ketones, esters and carboxylic acids in particular can emerge from the fabric doe to oxidative polymerization. These released substances, which usually contain volatile organic compounds such as formaldehyde, can cause cancer, alter the chromosomes, endanger the reproductive system, and be toxic.

At present, UV-cured lacquers are being used particularly as suitable coatings for flooring, which are supposed to improve the aforementioned properties of the base material and which usually have a lower degree of emission of volatile organic compounds as compared to heat-cured lacquers. In the field of UV-cured lacquers, one uses photoinitiators that are transformed by UV light into an active species, thereby starting the cross-linking process, i.e., the polymerization. Different polymerization methods are classified according to the reaction conditions. In addition to cationic UV curing, the generating of free radicals (radical polymerization) plays the most important role here.

Customary UV-curable coatings generally contain between 0.5 and 8 wt. % of a photo initiator, as described in P. Glöckner et al., “Radiation Curing for Coatings and Printing Inks: Technical Basics and Applications”, Vincentz Network 2008, page 18. For example, coatings based on polyurethane (PUR) are used in this way in the prior art, being applied in the form of a liquid layer, and after curing they form a permanent and tough protective film, which protects the corresponding base layer against dirt and damage of every kind.

UV-cured coatings due to the chemical composition of the photoinitiators used can also constitute a source of emissions. A further drawback of UV-cured coatings, in the case of a PUR coating for example, is that the degree of cross-linking is limited, which can limit in particular the gas barrier function of the coating.

For example, emission measurements of linoleum with a PUR coating using a Field and Laboratory Emission Cell (FLEC) show that both unreacted. photoinitiator and unpolymerized monomers are emitted. The emission factor of all volatile organic compounds in the case of PUR-coated linoleum is usually around 150 μg/m²h (measured per ISO 16000-10).

Furthermore, other methods are known for forming coatings that attempt to improve the aforementioned drawbacks. In DE 10 2008 061 244 A1 a method is described for direct triggering of the polymerization and cross-linking of (meth)acrylates by UV radiation, wherein a source of high-energy photons is combined with a medium-pressure mercury discharge lamp. Due to the high-energy photons that trigger processes of radical formation in (meth)acrylates, this technique can dispense with photoinitiators. Accordingly, coating that are made by the aforementioned method have no emission attributable to photoinitiators.

Against this background, the present invention is based on the problem of providing a sheet material that has improved environmental qualities as compared to the prior art. In particular, a sheet material is to be provided whose degree of emission of volatile organic compounds is substantially reduced. In addition, it is desirable to provide a sheet material that provides improved functional properties such as improved wear resistance and stain resistance.

This problem is solved by the objects characterized in the claims.

### SUMMARY

Some embodiments of the present invention provide a sheet material, comprising at least one base layer and a (meth)acrylate-based coating arranged thereon, wherein the sheet material has a TVOC (total volatile organic compounds) value of ≦50 μg/m²·h, measured according to ISO 16000-10 by means of a field and laboratory emission cell (FLEC). In some embodiments, the sheet material is a flooring tile, plank or sheet.

Other embodiments provide methods for producing a sheet material comprising: providing a base layer, optionally containing a substrate and additional layers, and providing a (meth)acrylate-based coating on this base layer, wherein the (meth)acrylate-based coating is cured by irradiation using a source of high-energy photons in combination with a UV radiator.

As used herein, the terms “(meth)acrylate” or “(meth)acrylates” indicate that the particular component with which the term is associated, may comprise an acrylate or a methacrylate.

Further embodiments provide the use of any one of the sheet materials described herein as a wall covering, ceiling covering, floor covering, decorative covering, piece of furniture or veneer.

Still further embodiments provide methods for producing a wear layer on a substrate comprising: applying a radiation curable composition comprising a (meth)acrylate resin to a substrate; and irradiating the composition with a source of radiation, having a wavelength of from 10 nm to 200 nm.

### DETAILED DESCRIPTION

As used herein, “UVV” refers to UV radiation having the strongest wavelengths between 400-450 nm.

As used herein, “UVA” refers to UV radiation having the strongest wavelengths between 315-400 nm.

As used herein, “UVB” refers to UV radiation having the strongest wavelengths between 280-315 nm.

As used herein, “UVC” refers to UV radiation having the strongest wavelengths between 100-280 nm.

As used herein, “VUV” refers to UV radiation having the strongest wavelengths between 10-200 nm. Excimer lamps typically operate in VUV spectrum.

In particular, a sheet material is provided, comprising at least one base layer and, arranged on this, a coating based on (meth)acrylate, wherein the sheet material has a TVOC (Total Volatile Organic Compounds) value, as measured according to ISO 16000-10 with a Field and Laboratory Emission Cell (FLEC), of ≦50 μg/m²·h, the TVOC value of the sheet material being preferably ≦35 μg/m²·h, more preferably ≦20 μg/m²·h and especially preferably ≦10 μg/m²·h.

Surprisingly, it has been found that the TVOC value of a sheet material can be substantially reduced if the base layer is provided with a coating based on (meth)acrylate that is cured in a accordance with the present invention, as is described hereafter in detail. This makes it possible to provide an almost or entirely odor-neutral sheet material, since the degree of emission of volatile organic compounds, being the source of unpleasant odors, is substantially reduced. Furthermore, the sheet material of the invention has the surprising advantage for a consumer that its lifetime can be substantially lengthened on account of the tough coating. Furthermore, the sheet material of the invention is characterized by less maintenance expense, so that costly and time-consuming cleaning and upkeep work can be substantially reduced.

The sheet material of the invention involves, in particular, a sheet material in which the coating based on (meth)acrylate is cured by irradiation with a source of high-energy photons in combination with a UV lamp, while the concentration of a photoinitiator in the uncured coating composition is reduced as compared to the prior art. Surprisingly, it has been found that the TVOC value of a sheet material is especially low when the concentration of the photoinitiator in the uncured coating composition in terms of the total mass of solids of the coating is 0.01 to 5 wt. %.

The compositions may include about 0.5% to about 10% by weight of a photoinitiator, more typically between about 1% to about 5% by weight. According to one embodiment of the present invention, the concentration of the photoinitiator in the coating composition is at least 0.1 wt %, more preferably at least 0.5 wt. % and especially preferably at least 0.7 wt %. The upper limit for the concentration of the photoinitiator is preferably 3 wt. %, more preferably 2 wt. %, and especially preferably 1.3 wt. %.

The photoinitiators known to the skilled person can be used as photoinitiators according to the present invention. Generally suitable are photoinitiators in which the formation of radicals occurs by a hemolytic cleavage. One can mention here as nonlimiting examples benzoin derivatives, benzyl ketals, α-hydroxyalkylphenones, α-aminoacetophenones or acylphosphinoxides.

The photoinitiator may be, but is not necessarily, a free radical photoinitiator. Suitable free radical photoinitiators include unimolecular (Norrish Type I and Type II), bimolecular (Type II), and biomolecular photosensitization (energy transfer and charge transfer). Exemplary classes of free radical photoinitiators that may be employed include, but are not limited to, diphenyl ketone, 1-hydroxycyclohexyl phenyl ketone, phenyl bis(2,4,6-trimethyl benzoyl)phosphine oxide, Esacure KTO-46 (a mixture of phosphine oxide, Esacure KIP150 and Esacure TZT), 2,4,6-trimethylbenzoyldiphenyl phosphine oxide, isopropylthioxanthone, 1-chloro-4-propoxy-thioxanthone, 2,4-diethylthioxanthone, 2-chlorothioxanthone, camphorquinone, 2-ethyl anthraquinone, as well as Irgacure 1700, Irgacore 2020, Irgacure 2959, Irgacure 500, Irgacure 651, Irgacure 754, Irgacure 907 all available from Ciba. Other photoinitiators that may be employed include such as Speedcure BP and Speedcure 84 all available from Lampson and Benzophenone diphenyl ketone from Parke Davis.

Suitable cationic photoinitiators include iodonium salts and sulfonium salts, such as triarylsulfonium hexafluoroantimonate salts, triarylsulfonium hexafluorophosphate salts, and bis(4-methylphenyl)-hexafluorophosphate-(1)-iodonium. Suitable photosensitizers for the cationic photoinitiators include isopropyl thioxanthone, 1-chloro-4-propoxy-thioxanthone, 2,4-diethylthioxanthone, and 2-chlorothioxanthone, all by way of example only.

Furthermore, photoinitiators are suitable in which the formation of radicals occurs via hydrogen removal. For example, one can mention compounds based on aromatic ketones, such as benzophenones, thioxanthones, camphor quinones plus co-initiator, usually tertiary amines. Moreover, according to the present invention, mixtures of the aforementioned types of photoinitiators, e.g., a mixture of benzophenone and α-hydroxycyclohexylphenylketone (product name: Esacure HB).

It will be appreciated that in some cases, an amine synergist may be used in combination with the free radical photoinitiators. Examples of amine synergist include, but are not limited to, 2-ethylhexyl-4-dimethylamino benzoate, ethyl 4-(dimethylamine)benzoate, N-methyl diethanolamine, 2-dimethylamino ethylbenzoate, and butoxyethyl-4-dimethylamino benzoate, as well as CN371, CN373, CN383, CN384, CN386 all available from Sartomer; Ebecry P104, Ebecry P115, Ebecry 7100 all available from Cytec; and Roskydal UA XP 2299 available from Bayer. The range of the amine synergist is from 0.5% to about 15% by weight in the coating composition, more typically between about 1% to about 5% by weight. An amine synergist may be used with these free radical photoinitiators. Examples of amine synergist include, but are not limited to, 2-ethylhexyl-4-dimethylamino benzoate, ethyl 4-(dimethylamine)benzoate, N-methyl diethanolamine, 2-dimethylamino ethylbenzoate, and butoxyethyl-4-dimethylamino benzoate.

In some embodiments, compositions of the present invention may be low gloss coatings that contain one or more flattening agents that may be dispersed within the composition reduce the gloss level of the cured composition. Flattening agents that may be used re usually inorganic, typically silica, although organic flattening agents or a combination of inorganic and organic materials may be used as flattening agents. Examples of such flattening agents include but are not limited to, ACEMATT HK125, ACEMATT HK400, ACEMATT HK440, ACEMATT HK450, ACEMATT HK460, ACEMATT OK412, ACEMATT OK 500, ACEMATT OK520, ACEMATT OK607, ACEMATT TS100, ACEMATT 3200, ACEMATT 3300 all available from Evonik; MPP-620XXF, Polyfluo 150, Propylmatte 31 all available from Micropowders; Ceraflour 914, Ceraflour 913 all available from BYK; Gasil ultraviolet70C, Gasil HP280, Gasil HP 860, Gasil HP 870, Gasil IJ 37, Gasil ultraviolet 55C all available from PQ Corporation; Minex 12, Minex 10, Minex 7 and Minex 4 all available from Unimin.

Where a plurality of flattening agents is employed, the flattening agents may differ by chemistry (i.e., composition), particle size, particle size distribution, surface treatment, surface area and/or porosity. The total amount of flattening agent in the compositions may vary from about 1% to about 30% by weight, more typically between about 3% to about 15% by weight based on percent weight of the total formula.

The compositions also may include one or more abrasives and one or more surfactants. Abrasives that may be employed include but are not limited to PWA30 alumina from Fujimi. Surfactants that may be employed include but are not limited to BYK 3530 from BYK Chemie.

In some embodiments of the present invention, the coatings are lacquers based, on (meth)acrylate whose principal component is acrylates and/or methacrylates. In some embodiments, the coatings are lacquers based on (meth)acrylate whose principal component is methacrylates. According to the invention, the fraction of the acrylates and/or methacrylates in the lacquers is at least 30 wt. %, preferably at least 40 wt %, especially preferably at least 50 wt. % in terms of the total mass (solid content) of the lacquer applied. The lacquers used can contain other components besides (meth)acrylates, which can bring about advantageous properties of the coating depending on the area of application. These additional components are sufficiently well known to the skilled person and need not be mentioned in detail. As an example, one can mention additives, pigments and inorganic or organic admixtures, if when added to the (meth)acrylate matrix they do not negatively influence the cross-linking.

Any suitable acrylate resins may be used, although the compositions may include at least one resin selected from the group consisting of urethane acrylates, polyester acrylates and combinations thereof. Urethane acrylates and polyester acrylates may be commercially obtained or prepared, for example, according to the procedures disclosed in U.S. Pat Nos. 5,719,227, 5,003,026, and 5,543,232, as well as in U.S. Application Publication. No. 20090275674, all of which are hereby incorporated by reference in their entireties.

Non-limiting examples of acrylate resins that may be used in accordance with exemplary embodiments include EC6360, EC6154B-80, EC6115J-80, EC6142H-80, and EC6145-100 all available from Eternal; Actilane 579 and Actilane 505 available from AkzoNobel; Roskydal VP LS 2110, Roskydal UA VP LS 2266, Roskydal UA VP LS 2380, Roskydal UA VP LS 2381 (XD042709), Roskydal UA XP 2416, Desmolux U200, Desmolux U680H, Desmolux XP2491, Desmolux XP2513, Desmolux P175D, Roskydal UA TP LS 2258, Roskydal UA TP LS 2265, and Roskydal UA XP 2430 all available from Bayer; CN965, CN966 A80, CN966 J75, CN981, CN991, CM2920, CN2282, CN985B88, CN2003R, SR 3010, SR 9035, SR833S, SR531, CD420, CD611, SR 351, SR 306, SR395, SR 238, SR399, 2-EHA, SR324, SR257, SR-502, and SR203 all available from Sartomer; Ebecryl 230, Ebecryl 270, Ebecryl 4830, Ebecryl 4833, Ebecryl 4883, Ebecryl 8402, Ebecryl 8405, Ebecryl 8411, Ebecryl 8807, and Ebecryl 809, dipropylene glycol diacrylate (DPGDA), neopentyl glycol propoxylate (2) diacrylate (NPG(PO)2DA), trimethylolpropane ethoxy triacrylate (TMPEOA), isobornyl acrylate (IBOA), Ebecryl 114, and Ebecryl 381 all available from Cytec; and Polyfox 3305, PolyFox 3320, and Polyfox 3510, all available from Omnova. The foregoing acrylates are presented by way of example only and not by way of limitation. Typically a combination of multiple acrylate resins are present in the composition and together make up about 65 to about 95 percent by weight of the composition.

Furthermore, the coating composition, i.e., the lacquer being laid down, can contain other polymerizable monomers and/or oligomers besides the (meth)acrylate matrix, such as urethanes, for example. Typical formulations of the lacquer applied contain oligomeric binder resins and a slight fraction of photoinitiator, and optionally reactive monomers and other additives, such as flow control agents. According to the present invention, one advantageously uses lacquers whose principal components are epoxy(meth)acrylates, which are produced for example by addition of acrylic acid to epoxides. According to the invention, the (meth)acrylate matrix of the lacquer being laid down can have other oligomers, which are produced for example by esterification of polyester or polyether ols or by addition of hydroxyalkylacrylates to polyisocyanates. Thus, by combination of the different resin types, the desired properties of the coating can be adjusted.

The suitable oligomers or polymers (binders) include in particular epoxy (meth)acrylates, urethane (meth)acrylates, saturated and unsaturated polyester (meth)acrylates, polyether (meth)acrylates, including aminofunctionalized polyether (meth)acrylates, acrylated (meth)acrylates and silicone (meth)acrylates. Suitable as binders for so-called dual cure systems are, for example, isocyanate-functionalized oligomers and polymers, as described above, in combination with hydroxy-functional binders.

As described above, the lacquer being laid down can further contain reactive diluents, which can influence the properties of the lacquer depending on their functionality, i.e., monofunctional monomers, difunctional monomers or polyfunctional monomers. It is familiar to the skilled person that monofunctional monomers can reduce the cross-linking density, which, for example can improve the flexibility, as well as the adhesion. On the other hand, with the help of polyfunctional monomers, the curing speed and the cross-linking density can be increased.

In embodiments in which the curable composition includes a methane acrylate and/or polyester acrylate, the ultraviolet curable acrylate resin component also may include a reactive diluent where the coating is to be used in flooring applications. If employed, the reactive diluent may be present in an amount of about 0.1% to about 90% by weight of the composition, more typically between about 5% to about 70% by weight.

Non-limiting examples of acrylate reactive diluents include, but are not limited to, (meth)acrylic acid, isobornyl(meth)acrylate, isodecyl(meth)acrylate, hexanediol di(meth)acrylate, N-vinyl formamide, tetraethylene glycol (meth)acrylate, tripropylene glycol(meth)acrylate, neopentyl glycol di(meth)acrylate, ethoxylated neopentyl glycol di(meth)acrylate, propoxylated neopentyl glycol di(meth)acrylate, trimethylolpropane tri(meth)acrylate, ethoxylated trimethylolpropane tri(meth)acrylate, propoxylated trimethylolpropane tri(meth)acrylate, ethoxylated or propoxylated tripropylene glycol di(meth)acrylate, pentaerythritol tri(meth)acrylate, pentaerythritol tetra(meth)acrylate, tris(2-hydroxy ethyl)isocyanurate tri(meth)acrylate and combinations thereof.

For example, the following composition can be indicated for a suitable lacquer recipe:
(meth)acrylates: 30 to 100 wt. %
reactive diluents: 0 to 50 wt. %
photoinitiator: 0.01 to 5 wt. %
additives: 0 to 15 wt. %
pigments/fillers: 0 to 30 wt. %

According to one preferred embodiment of the present invention, the lacquer is solvent-free, and a lacquer primarily based on renewable raw materials is especially preferred. According to the invention, the fraction of renewable raw material in the lacquer is preferably at least 30% wt. %, more preferably at least 50% wt. % and especially preferably at least 70% wt. %. One can use for this, for example, binders based on plant oils and/or sugars, which can advantageously minimize the use of binders based on renewable raw materials and those based on petroleum. By renewable raw materials is meant organic raw materials that come from agricultural and forestry production. As examples, one can mention wood, natural fibers, plant oils, sugar and starch, chemical and pharmacological base materials and raw materials of animal origin.

According to the invention, by high-energy photons is meant gamma radiation and

X-rays whose wavelength is shorter than that of UV radiation, i.e., less than roughly 10⁻⁸ m. Preferably, excimer lamps are used as the source of high-energy photons. In particular, one can use, for example, xenon or argon lamps, which, are operated in a protective gas atmosphere. As a possible inert gas, one can use argon, nitrogen, or a mixture thereof preferably nitrogen. According to the invention, however, the excimer lamp to be used is not limited to the aforementioned xenon or argon lamps and can be adapted in its wavelength to the type of surface configuration desired. Suitable excimer lamps are described, for example, in DE 10 2006 042 063 A1,DE 10 2005 060 198 A1 or DE 10 2008 061 244 A1.

By the use of an excimer lamp in combination with a UV lamp for the stepwise curing of the lacquer (i.e., the coating composition) it is furthermore possible to adjust the shine and the feel of the lacquer surface, since a desired structure can be created on the surface, i.e., a so-called microfolding structure. A desired surface structure can be frozen in between initiation and completion of the curing by excimer lamp and then be cured with a UV lamp. As a result, this technique, as described for example in DE 10 2006 042 063 A1, enables both an adjusting of the shine over a broad range and the adjusting of the surface feel, i.e., from a smooth to a rough surface.

According to one preferred embodiment of the present invention, the shine of the sheet material according to the invention can be adjusted by means of the above-described technique. As the preferred range, the sheet material of the invention has a shine of 10 to 15 according to DIN 67530 at 60°.

Moreover, with the above-described technique for configuring the microfolding structure, the surface feel of the sheet, material, according to the invention can be adjusted so that the sheet, material has an antislip quality of surface. According to one preferred embodiment of the present invention, the overall acceptance angle per DIN 51130:2010 is at least 6° and at most 10°. This corresponds to class R 9 of slip resistance. According to the present invention, the above-described microstructuring can thus be design-supporting and/or functional (e.g., slip resistance).

Furthermore, the sheet material according to the invention is distinguished by high abrasion resistance. The abrasion value of the sheet material, i.e., the resistance to abrasion, can be determined by DIN EN 13329. According to one preferred embodiment of the present invention the abrasion value is up to AC 3.

Due to the coating of the sheet material according to the invention it is furthermore possible to increase the stain resistance of the sheet material. For example, measurements per EN 423 show that the sheet material of the invention is very resistant to chemicals. The testing with, e.g., an aqueous iodine solution (2%) or eosin solution (1% in 1:1 water-ethanol mixture) leads to a score of 1 or better.

In addition, the sheet material of the invention is furthermore characterized by a good scratch and/or wear resistance. Thus, the sheet material of the invention is not only low in emissions, but also highly resistant to external factors. The scratch resistance can be tested by means of a test method based on DIN EN 660-1 (Egner abrasion-Stuttgart Test).

The excimer lamp is used in an inert gas atmosphere, as already mentioned, and the oxygen, content should be as low as possible, since this absorbs the energy-rich radiation, so as to obtain the highest possible radical density. Preferably, the oxygen concentration is less than 300 ppm and especially preferably less than 200 ppm.

As already mentioned, the curing of the coating according to the invention occurs in an additional step by UV irradiation. Preferably, the irradiation of the uncured coating composition occurs in time and space immediately after the irradiation with high-energy photons. In an especially preferred embodiment of the present invention, mercury discharge lamps or UV LEDs are used for the UV irradiation step. UV radiation sources with different, wavelengths coordinated to the lacquer being used have proven to be especially suitable. For example, medium-pressure mercury discharge lamps are especially suitable.

The device described in DE 10 2008 061 244 A1 can be an especially suitable device for the curing of the coating.

Furthermore, it was found surprisingly according to the present invention that, contrary to the methods described in the prior art for the curing of lacquers based on (meth)acrylate by means of irradiation with a source of high-energy photons in combination with a UV lamp, the additional step of UV curing does not need to be carried oat necessarily in an inert atmosphere. More details on carrying out the curing of the coating are described further below.

According to the present invention, the at least one base layer of the sheet material according to the invention is based on synthetic, such as PVC, polyolefins, or PUR, or based on rubber, or based on textile materials or on renewable raw materials, such as wood, linoleum or korkment, but without being limited to these. According to one preferred embodiment of the present invention, the at least one base layer of the sheet material according to the invention is based on renewable raw material, such as linoleum or korkment. According to this preferred embodiment, the base of linoleum and korkment can resort preferably and predominantly to renewable raw material, so that chlorine-containing polymers can be dispensed with, for example.

According to the present invention, these renewable raw materials can optionally be subjected to one or more derivatization/processing/modification steps before being used as a component of the sheet material,

As already mentioned above, emission measurements by means of a FLEC test show, even for PUR-coated linoleum, that both unreacted photoinitiator and unpolymerized monomers are emitted. The TVOC value of an uncoated linoleum substrate, however, is even higher than that of the PUR-coated linoleum, clue to the aforementioned oxidative polymerization reactions in the linoleum.

According to the present invention, however, it was surprisingly discovered that even a sheet material based on linoleum or korkment having a coating based on (meth)acrylate arranged on top of it, which is cured in the special way according to the present invention, has a distinctly lower TVOC value. Thus, the invention has succeeded in providing low-emission sheet materials despite the use of renewable raw materials as the base material, which are per se high in emissions.

According to the present invention, the base layer of linoleum comprises customary components, such as binders (so-called Bedford cement or B-cement of partly oxidized linseed oil and at least one resin as tack-producing agent), at least one filler and optionally at least one colorant. The fillers used are customarily powdered softwood and/or powdered cork (if both powdered softwood and powdered cork are present, at the same time, typically the weight ratio is 90:10) and/or chalk, kaolin (China clay), kieselguhr and barite. In addition, to stiffen the mass, one can add as fillers precipitated silicic acid and slight amounts of water glass, such as water glass in a quantity of up to 15 wt. % in terms of the quantity of the layer.

The linoleum mix mass typically contains at least one colorant, such as an inorganic (e.g., titanium dioxide) and/or an organic pigment, and/or other typical colorants. Any natural or synthetic dyes can be used as the colorant, as well as inorganic or organic pigments, alone or in any given combination.

A typical linoleum composition contains, in terms of the weight of the linoleum layer, around 40 wt. % of binder, around 30 wt. % of organic substances, around 20 wt. % of inorganic (mineral) fillers and around 10 wt. % of colorant. Moreover, typical additives can be contained in the linoleum mix mass, such as processing aids, UV stabilizers, lubricating agents, dimension stabilizers and the like, which are chosen in dependence on the binder.

As examples of dimension stabilizers one can mention chalk, barium sulfate, slate flour, silicic acid, kaolin, quartz flour, talc, lignin, cellulose, powdered glass, textile or glass fibers, cellulose fibers and polyester fibers, which can be used in a quantity of around 1 to 20 wt % in terms of the overall weight of the particular layer.

According to the present invention, the base layer of korkment comprises a mixture, which comprises B-cement and ground cork as filler, by analogy with the above description of the base layer of linoleum, but the ground cork as filler takes up a substantially higher fraction (DIN EN 12455) as compared to the composition of linoleum (DIN EN 548). Thus, a typical korkment composition, in terms of the weight of the korkment layer, contains around 40 wt. % of binder, around 40 wt. % of ground cork, around 20 wt % of inorganic (mineral) filler and optionally colorant. Moreover, typical additives can be contained in the korkment mix mass, such as processing aids, antioxidants, UV stabilizers, lubricating agents, dimension stabilizers and the like, which are chosen in dependence on the binder.

Examples of dimension stabilizers are those mentioned above. The possible fraction is roughly 1 to 20 wt. % in terms of the overall weight of the particular layer.

The linoleum or korkment layer preferably has a thickness of 0.3 to 6 mm, especially preferably 0.5 to 4 mm.

In the sheet material according to the invention, the linoleum or korkment layer can be either a single layer or a multiple layer. In the latter case, there are symmetrical as well as asymmetrical sheet, materials, depending on the sequence of layers. For example, the sheet material of the invention can comprise two layers of linoleum (homogeneous in material), which can be the same or different.

The base layer of linoleum in the sheet material of the invention can furthermore be prepared with or without a carrier.

Furthermore, underneath the linoleum layer can be arranged a korkment layer with or without a carrier. As already described above, korkment is a mixture that contains B cement and ground cork as filler, and in flooring based on linoleum it serves as an insulating underlayer for better thermal insulation, step flexibility and walking comfort, and it muffles walking and room noises.

According to another preferred embodiment of the present invention, additional functional layers can be arranged in the sheet material of the invention, so that three-layer or multiple-layer sheet materials result. For example, underneath the linoleum layer of the invented sheet material there can be arranged at least one additional layer, preferably a foam layer, which can be based on polyester, for example, a layer for muffling of walking noise, and/or an insulating layer. The thicknesses of the layers can be the same or different,

According to one preferred embodiment of the present invention, the sheet material is predominantly made from renewable raw materials. Preferably according to the invention the layers different from the base layer of linoleum or korkment also comprise renewable raw materials at least in part. Thus, in terms of the overall sheet material, when the additional layers are also based on renewable raw materials, a fraction for these can be specified at ≧45%, preferably ≧55% and most preferably ≧75%.

According to the present invention, the coating based on (meth)acrylate can be transparent. By ‘transparent’ in the context of the present invention is meant a condition in which the optical impression of a design pattern, for example, is not affected. This allows the base layer of linoleum or korkment to have an imprinting and thus contribute to the color and design pattern of the sheet material of the invention. In addition, the sheet material of the invention can optionally comprise additional layers, by which the color and design pattern can be varied, for example. It is advantageous, for example, to arrange another nontransparent layer (white film) between the transparent coating based on (meth)acrylate (top layer) and the base layer.

The thickness of the top layer of the sheet material of the invention is not particularly limited and can be adjusted in regard to the respective purpose of use of the sheet material of the invention. Usually the mean thickness of the top layer is 0.5 μm to 200 μm. When the thickness of the top layer is too little, this has negative effects on the reduction of emissions. On the other hand, if the toughness of the sheet material is supposed to be especially good, the thickness of the top layer car be increased accordingly, while a thickness of at least 1 μm is preferred, one of at least 3 μm is more preferred, and one of at least 5 μm is especially preferred. The upper limit on the thickness of the top layer is preferably 100 μm, more preferably 50 μm and especially preferably 30 μm. The applying of the top layer can be done, according to the invention, in a onetime application step. However, this application step can be repeated for a desired quality of the sheet material that one wants to obtain.

Furthermore, the sheet material of the present invention can have an embossing. This can be an irregular embossing, such as a fine embossing to make the surface matte. Furthermore, an embossing of the coating based on (meth)acrylate on its wearing surface can advantageously provide slip resistance according to the invention. This embossing can be done instead of or in addition to the aforementioned microstructuring of the surface.

The aforementioned embossings between the layers, which can also be present on additional layers in the sheet material of the invention, as will be described below, can advantageously impart a three-dimensional appearance to the sheet material in addition or instead. If several surfaces of respective layers are provided with such embossings, this effect will be further enhanced. Furthermore, or instead, the base layer of linoleum or korkment before or after it is cured can be configured with a variation in thickness or with such an embossing on its surface facing the top layer, by which the aforementioned three-dimensional effect can be further strengthened or established.

According to the present invention, the aforementioned embossing can thus be design-supporting and/or functional (e.g., slip resistance).

In addition or alternatively, every other layer of the sheet material, even additional layers as described below, especially the top layer, can be varied in their thickness in order to create or strengthen a three-dimensional impression.

Advantageously, the additional embossing on the uppermost surface is a uniform embossing or an embossing with a regular pattern of elevations and depressions, since such an embossing can significantly improve the soiling behavior of, say, a flooring. This effect is also known as the “lotus effect”. It has been found that the effect of the additional surface structuring is most pronounced when the average distance between profile peaks in the midline, corresponding to the so-called Sm value or groove spacing Sm per DIN 4768, lies in a range of more than 200 μm and less than 1000 μm.

As regards the height of the elevations (mean relief Rz per DIN 4768) of the embossed material, a value in the range of 0.1 μm to 20 μm has proven to be advantageous. The embossing can be done, for example, with an embossing roller or, as described above, by the microfolding technique. In this way, surprisingly, it is possible to produce a sheet material that, although based on renewable raw materials, is not only odor-neutral and tough, but also easy to clean.

Alternatively, the embossing of the sheet material of the invention can also have a coarse structure, i.e., the groove spacing is increased compared to the above values. In this way, the sheet material of the invention can be prepared advantageously in the form of a safety flooring.

As was previously mentioned, the sheet material in accordance with the invention can include an additional layer by means of which the color and design format of the sheet material can be varied. This is done, for example, using a printed (white) film sheet disposed between the base layer and the covering layer. Such an additional layer can also include an electrically conductive component. By means of this it is possible to vary the electrical properties of parts or all of the respective layer(s), such as conductivity/charge dissipation capability and resistance, in an advantageous manner, resulting in different functions for the resulting sheet material. According to the present invention, for example, among other things, all or part of the surface may be printed with an electrically conductive dye, which can lead to the formation of, for example, circuit tracks, antennas, (pressure-sensitive) sensors, etc, and makes the imprinted sheet material usable for electronic purposes. In a particular embodiment, this electronic usability can make the sheet material according to the invention “interactive,” i.e., for example, information can be exchanged and/or commands can be input.

In addition, instead of the printing or in addition to the printing, a metal layer may be deposited on the above-mentioned film sheet. Vapor deposition of a metal layer, which can for example produce the effect of a metal mirror, is preferably done on the side of the additional layer or film facing the covering layer. Alternatively, a metal layer may also deposited in addition to or onto the covering layer, wherein in analogy to the optional additional layer, the surface is coated with a metal layer on the side facing away from the base layer.

Thus according to the present invention, the metal layer described in the preceding can be design-supporting and/or functional (e.g., electrical conductivity).

Each of the aforementioned layers, especially the covering layer and the optional additional layer(s), can be made in one or more layers. For reasons of production technology and costs, it is often more advantageous to Join two or more thin films (for example by lamination) to achieve the desired effect.

The overall thickness of the sheet material according to the invention is preferably from 0.5 to 6.5 mm, wherein an overall thickness of 1.5 mm to 4.5 mm is preferred.

According to the present invention, the sheet material preferably has the form of a strip or panel. If the sheet material of the present invention exists in the form of a panel, this can be equipped with an installation aid. Such installation aids are, for example, so-called Klick [click-fit] systems, which permit easy installation of the panels, for example in the form of a floor covering. In this case the application of such click-fit systems may take place, for example, after the sheet material of the present invention is finished.

In addition, the present invention presents a method for producing the above-described sheet material. In particular, the present invention presents a method for producing a sheet material comprising at least one base layer and a (meth)acrylate-based coating arranged on it, wherein the sheet material has a TVOC value (Total Volatile Organic Compounds) measured according to ISO 16000-10 using a Field and Laboratory emission cell (FLEC) of >50 μg/m²h, comprising the following steps:

preparing a base layer, optionally with a backing, and

preparing a (meth)acrylate based coating on this base layer,

wherein the methacrylate-based coating is cured by irradiating with a source of high-energy photons in combination with a UV emitter. The concentration of a photoinitiator used in the uncured coating relative to the total weight of the solids in the coating is preferably 0.01 to 5 wt %.

According to the present invention, the preparation of the at least one base layer of the sheet material according to the invention is not limited. If at least one base layer is a plastic- or rubber-based layer, this can be prepared by known manufacturing methods. Likewise the preparation of the at least one base layer on a base of textile materials or renewable raw materials is not restricted.

As was previously mentioned, the at least one base layer of the sheet material according to the invention is preferably based on renewable materials, for example linoleum or korkment. In the case of linoleum or korkment, these can be manufactured by conventional static (e.g., pressing) or dynamic (e.g., rolling) methods for producing single-layer or multilayered linoleum or korkment sheet materials with or without a backing. The processing of linoleum, or korkment cements, which are produced according to the requirements of DIN EN 548 or DIN EN 12455 from dry vegetable oils or vegetable fats and tree gums, takes place correspondingly.

According to a preferred embodiment, the sheet material according to the invention can include additional functional layers. In this case the optional additional layers are arranged on the base layer as described above, and then are connected together positively under application of pressure and heat. This can be done, for example, with an automated laminating machine using pressure (typically 8-30 N/cm²) and temperature (typically about 110 to 160° C.) over a period of about 10 to 300 seconds. In addition, these layers can also be laminated using pairs of rollers.

Alternatively, the lamination of the at least one base layer and the additional layers can also be done in a static press. In this instance, the pressure is typically about 5 to 500 N/cm² and the temperature is typically about 90 to 180° C. over a period of about 2 to 20 minutes,

After the at least one base layer, optionally with additional functional layers, has been prepared, a (meth)acrylate-based coating is prepared on this, wherein the (meth)acrylate based coating is cured by irradiating with a high-energy proton source in combination with a UV radiation emitter. For this purpose, the (meth)acrylate-based coating is arranged on the base layer, which optionally contains additional functional layers, in the form of a thin layer. This can be accomplished using measures known to persons skilled in the art, for example, roller application, “curtain coating,” spreading, spraying, rolling, etc, wherein the non-cured coating is preferably a liquid lacquer.

According to the present invention, the applied, non-cured coating is first exposed to high-energy photon irradiation, preferably using excimer emitters as their source. Xenon or argon emitters operated in an inert gas atmosphere are especially preferred for this purpose. Argon or nitrogen may be used as the inert gas. Alternatively, a mixture of these can be used, wherein the oxygen content should be as low as possible, since this [oxygen] absorbs the high-energy radiation and thus reduces the free radical density. Preferably the oxygen concentration is less than 300 ppm and particularly preferably less than 200 ppm.

As was previously mentioned, the final curing of the coating according to the invention is performed in an additional step using UV radiation. Preferably the irradiation of the non-cured coating takes place immediately following, in time and space, the irradiation with high-energy photons. In a particularly preferred embodiment of the present invention, mercury emitters or UV LEDs are used, wherein particularly preferably UV radiation sources with various wavelengths in agreement with the lacquer applied are used. For example, medium-pressure mercury emitters are used.

The irradiation times of the various radiation sources are not particularly limited according to the invention and can be adjusted depending on the lacquer used and the quantity thereof, wherein preferably at least 80%, more preferably at least 90%, particularly preferably at least 95% of the acrylate double bonds react. According to the invention, the irradiation is typically performed in that the (meth)acrylate-based coating is passed through an irradiation unit and cured. Typical travel rates are 1 to 50 m/min, preferably 5 to 15 m/min.

As was previously mentioned, it was surprisingly found that the emission value of a sheet material cannot, for example, be minimized when the use of photoinitiators are dispensed with, but it can if the concentration thereof falls within a certain range, especially below that of the prior art. This is all the more surprising since photoinitiators in UV-curable coatings represent a source of emissions that pose a risk to health because of their chemical composition. The concentration of the photoinitiator used in the uncured coating according to the invention is 0.01-5 wt %, wherein according to a preferred embodiment, the lower limit is at least 0.1 wt %, more preferably at least 0.5 wt %, and particularly preferably at least 0.7%. The upper limit of the concentration of the photoinitiator preferably amounts to 3 wt %, more preferably 2 wt % and particularly preferably 1.3 wt %.

In addition, according to the present invention, it was surprisingly found that in contrast to the method described in the prior art, the curing of (meth)acrylate-based lacquers by irradiating with a source of high-energy photons in combination with a UV radiator, the additional step of UV curing need not necessarily be performed in an inert atmosphere. This advantageously makes it possible that in the additional step of UV curing, no inert atmosphere need be provided, so that cost-intensive and complex apparatus can be avoided.

As described in the preceding, in the method according to the invention for producing a sheet material, furthermore the gloss and haptics of the sheet material can be systematically adjusted by including the adjustment of the microfolding structure of the covering layer. According to a preferred embodiment, this makes it possible to supply a sheet material with a gloss level of 10 to 15 according to DIN 67530 at 60°. In addition, as described in the preceding, an antislip effect can be achieved by controlling the microfolding structure on the surface, wherein according to the invention an overall acceptance angle according to DIN 51130:2010 of between 6° and 10° is preferred.

Finally, the present invention proposed the use of a sheet material as described in the preceding as a wall covering, ceiling covering, floor covering, decorative covering, upholstery, or veneer. Preferred according to the invention is the use of the sheet material according to the invention as a floor covering. As a floor covering, the sheet material of the present invention may be supplied in the form of a strip, a panel or a tile.

Surprisingly and advantageously, the production, process according to the invention makes it possible to supply a low-emission sheet material, the TVOC value of which is distinctly reduced compared to known sheet materials. In this case, the combination of a special (meth)acrylate-based coating with a special curing method makes it possible to supply a sheet material, the TVOC value of which, measured with the FLEC test, is ≦50 μg/m²/h. In particular, the present invention permits at least part of the material used to be renewable raw material, wherein harmful emissions can be practically minimized, as a result of which the sheet material according to the invention is distinguished by its neutral odor, among other characteristics. In addition, despite its great freedom of design, because of the sturdy covering (abrasion resistance, scratch resistance, spot resistance) and its selectively modifiable surface performance (lotus effect, anti-slip, etc.), the sheet material according to the invention is characterized by low maintenance costs, so that laborious and cost-intensive cleaning and care work can be distinctly reduced.

Some embodiments of the present invention provide methods of producing a wear layer on a substrate. In some embodiments, a substrate to which a composition has been applied, is irradiated. In some embodiments, where coated flooring such as coated sheet such as coated linoleum sheet is exposed to UV, the flooring may be exposed to UV radiation by being passed under an array of UV lamps such as UV mercury lamps. In some embodiments, these methods may yield reduced TVOCs.

In some embodiments, the methods of the present, invention comprise coating a substrate with a UV curable coating composition that includes (a) a resin and (b) a photoinitiator. The composition may be precured by exposure to Excimer radiation followed by exposure to UV wavelength radiation such as from a mercury lamp. Alternatively, the composition may be cured by exposure to UV wavelength radiation such as from a mercury lamp without selected radiation from an Excimer lamp. The method of coating providing a flooring substrate, roller coating a UV curable composition onto the surface of the substrate, and curing the composition by irradiating the surface of the substrate with ultraviolet radiation.

Rates of movement of the substrate, distances from the lamps, and wattages of the lamps may vary. If will be appreciated that line speed, energy density and other variables of the curing process may depend on the particular formulation of the coating composition and the thickness to which it is applied, which may in turn depend on the substrate selected and the application for which it will be employed. Distances typically may range from about 1/16 in. (0.16 cm) to about 12 in. (30 cm), more typically between about 3/16 in. (0.19 cm) and about 6 in. (15 cm). Line speeds typically are about 6 ft./min (1.8 m/min) to about 100 ft./min (30 m/min), more typically about 40 ft/.min (12 m/min) to about 60 ft./min (18 m/min). Wattages of the UV lights may vary from about 20 watts/inch (7.9 watts/cm) to about 400 watts/inch (157 watts/cm). Typical Excimer lamps are rated at about 20 watts/inch (7.9 watts/cm).

In some embodiments, substrates (e.g. flooring samples) coated with the compositions shown in Table 6 (below) are cured by UV radiation by use of a Aetek model no. M550395 lamp from MILTEC UV while moving at a line speed of 50 ft./min (15.2 m/min). In some embodiments, the lamp operates at wattage of 400 Watts/inch (157 watts/cm) to generate an intensity of radiation of 420 mJ/441 mW UVA, 324 mJ/345 mW UVB, 59 mJ/61 mW UVC, and 176 mJ/195 mW VUV.

In some embodiments, the substrates are cured by exposure to UV radiation. In one aspect, the substrates are treated to UV radiation over the UVA, UVB spectra such as from a Hg UV lamp. In a second aspect, however, the coated substrates may be subjected to radiation from an Excimer lamp followed by exposure to a radiation spectrum such as from a Hg UV lamp. Hg UV lamps typically are capable of generating UV radiation over one or more of the UVA, UVB and UVC spectra. In this second aspect, the coated substrate first is exposed to Excimer radiation followed by exposure to radiation from an Hg lamp. However, the coated substrate also may be first exposed to UV radiation from an Hg lamp followed by exposure to an Excimer lamp.

Excimer lamps that may be employed operate at a selected wavelength such as about 172 nm, depending of power settings and wattage ratings. Suitable Excimer lamps are described, for example, in DE 10 2006 042 063 A1, DE 10 2005 060 198 A1 or DE 10 2008 061 244 A1. The teachings of each of DE 10 2006 042 063 A1, DE 10 2005 060 198 A1 and DE 10 2008 061 244 A1 are incorporated by reference herein by their entirety. Sources of Hg lamps include but are not limited to those produced by American Ultraviolet, Miltech, and 1ST.

In some embodiments, the coated substrates are heated to a temperature of about 77° F. (25° C.) to about 140° F. (60° C.) prior to exposure to UV. Where UV exposure is to UV radiation over any one or more of UVA, UVB and UVC spectra, temperatures of the substrates prior to UV exposure may range from about 80° F. (2° C.) to about 125° F. (52° C.), typically about 95° F. (35° C.) to about 115° F. (46° C.). Where UV exposure is to UV radiation from an Excimer lamp followed by UV exposure to any one or more of UVA, UVB and UVC spectra such as from an Hg UV lamp, temperatures of the substrate may vary from, about 80° F. (27° C.) to about 125° F. (52° C.), typically about 90° F. (32° C.) to about 115° F. (90° C.), prior to exposure to UV.

The coated flooring may be exposed to UV curing under various atmospheric conditions depending on the UV cure procedure employed. Where UV cure is by UV radiation over any one or more of UVA, UVB and UVC spectra, atmospheres that may be employed during UV exposure include but are not limited to inert, vacuum, or air atmosphere. Where UV exposure is to UV radiation from an Excimer lamp followed by UV exposure to any one or more of UVA, UVB and UVC spectra, atmospheres that may be employed during UV exposure to Excimer lamp radiation include but are not limited to inert, vacuum, or air atmosphere and atmospheres that may be employed during UV exposure to any of UVA, UVB or UVC spectra may include but not limited to inert, vacuum, or air atmosphere.

In some embodiments, the radiation (e.g. UV) curable compositions are deposited by roller coating or draw down onto a substrate such as flooring such as sheet linoleum as part of a continuous process at a desired line speed. In some embodiments, the compositions may be applied to a thickness of about 0.5 mil (0.013 mm) to about 2 mil (0.051 mm), typically about 0.1 (0.0026 mm) to about 0.5 mil (0.013 mm).

The UV curable compositions may be applied under a variety of atmospheres and over a range of atmospheric pressures. Suitable atmospheres include but are not limited to air and inert atmospheres such as N₂, He and Ar at oxygen levels as low as 30 ppm per square meter of material surface. The compositions also may be applied in vacuum.

The UV curable compositions after having been coated onto a substrate are typically cured as part of the continuous process under one or more banks of ultraviolet lights or other devices capable of emitting ultraviolet radiation. UV radiation may be applied over the UVV, UVA, UVB VUV and/or UVC spectra.

In some embodiments, flooring substrates to which the UV curable compositions may be applied may be of any size and include sheet goods such as linoleum. Examples of flooring include but are not limited to engineered wood; solid wood; tile that are cut from sheet goods; and individually formed tile, typically ranging from about one foot square to about three foot square, although tiles and other products may also be formed in other shapes, such as rectangles, triangles, hexagons or octagons, in some embodiments, such as in the case of tiles, engineered wood and solid wood, the flooring substrates may also be in the form of a plank, typically having a width in the range of about three inches to about twelve inches.

The present invention and additional advantages resulting from it will be explained in further detail in the description that follows, referring to the exemplified embodiments described in the examples.

### EXAMPLES

### Example 1

### Linoleum Base Layer

First, all the components for the linoleum composition listed in Table 1 below are mixed in a suitable mixing unit to form the most homogeneous possible base mass (mixed mass). The mixed mass thus obtained is processed into skins and conveyed to a scraper or granulator, after which the mixed mass particles thus obtained are conveyed to a calender and pressed, under pressure and a temperature of usually 10° C. to 150° C., onto jute, for example, as a base material. Then the sheet materials obtained are stored for 2 to 3 weeks in an aging chamber at about 80° C.

In Table 1 a formulation is listed as an example, in which the values shown are in wt %, relative to the quantity of the total mixture (linoleum layer). The individual constituents of the formulation specified in Table 1 are to be selected such that for each specific formulation for the linoleum layer, the value of 100 wt % results.

TABLE I

| Ingredient | Wt. % |
|---|---|
| Lino cement | 30-55 |
| Granulated cork | 0-25 |
| Wood flour | 5-45 |
| Chalk | 0-60 |
| Titanium dioxide | 1-15 |
| Colored pigments | 0-5 |
| Diatomaceous earth | 0-8 |
| Desiccant | 0-5 |
| Fire retardant | 0-30 |

### Example 2

### Coated Linoleum Base Layer

One coating per roller application is applied to this base layer, the composition and quantities of which are shown in Table 2. As is apparent from Table 3, the curing of the coating takes place initially by irradiating with an excimer lamp with a wavelength of 172 nm (Excirat 172) under a nitrogen atmosphere (oxygen content less than 150 ppm) with a linear speed of 10 m/min. In a second irradiation step with a mercury lamp (Printworld PUVD 270-2, without IR lamp, UV1 and UV2, 160 W/cm power) of the same linear speed, the coring of the coating is performed under a normal atmosphere.

TABLE 2

| | | Coating | |
|---|---|---|---|
| Example | Composition of coating | quantity | |
| 1 | No coating | | |
| 2 | No photoinitiator; 70 g M 215 ¹ and 40 g U100 ² | 16 | g/m² |
| 3 | No photoinitiator, 70 g M 215 ¹ and 40 g U100 ² | 18 | g/m² |
| 4 | 1% Esacure as photoinitiator, 70 g M 215 ¹ | 23 | g/m² |
| | and 40 g U100 ² | | |
| 5 | 1% Esacure as photoinitiator, 70 g M 215 ¹ | 36 | g/m² |
| | and 40 g U100 ² | | |
| 6 | Excimer lacquer LM 3674³ | 20 | g/m² |
| 7 | Excimer lacquer LM 3675⁴ | 20 | g/m² |

¹ Excimer lacquer M215 product of Innovative Oberflächentechologien GmbH (IOT)
² Excimer lacquer U100 product of Innovative Oberflächentechologien GmbH (IOT)
³Excimer lacquer LM 3674 product of Lott Lacke GmbH
⁴Excimer lacquer LM 3675 product of Lott Lacke GmbH

The conversion of the acrylic double bonds is followed by FTIR spectroscopy, wherein the band at 810 cm⁻¹ is observed, and in all instances amounts to more than 95%.

FTIR spectrophotometer used: ALPHA-P Spectrometer (Broker Optics GmbH) with ATR unit

TABLE 3

| Example | Remark | Thickness | Excimer | UV curing |
|---|---|---|---|---|
| 1 | No coating | | | |
| 2 | No PI; UV | Ca. 20 μm | 10 m/min; | 10 m/min; UV1 |
| | 1× | | 70% | and UV2 100% |
| 3 | No PI; UV | Ca. 20 μm | 10 m/min; | 10 m/min; UV1 and |
| | 2× | | 70% | UV2 100%; 2× |
| 4 | PI-reduced | Ca. 20 μm | 10 m/min; | 10 m/min; UV1 and |
| | | | 70% | UV2 100% |
| 5 | PI-reduced | Ca. 30 μm | 10 m/min; | 10 m/min; UV1 and |
| | | | 70% | UV2 100% |
| 6 | PI-reduced | Ca. 20 μm | 10 m/min; | 10 m/min; UV1 and |
| | | | 70% | UV2 65% |
| 7 | PI-reduced | Ca. 20 μm | 10 m/min; | 10 m/min; UV1 and |
| | | | 70% | UV2 65% |

### Example 3

### Emission Measurements

The emissions of these sheet materials obtained were measured using an FLEC test.

FLEC measurement cell used: Chematec (SCP Seitz Chromatographic Products GmbH); measurement performed after 28 days.

TABLE 4

| Parameter: FLEC | | | | |
|---|---|---|---|---|
| Volume FLEC measurement cell | 0.000035 | | m³ | |
| Sample area under FLEC | 0.0177 | | m² | |
| measurement cell | | | | |
| Air exchatme rate FLEC | 171 | | h⁻¹ | |
| measurement cell | | | | |
| Area-specific air exchange rate | 0.34 | | m³/m²h | |
| Total how FLEC | 100 | | ml/min | |
| Sample collection flow | 2 × 40 | | ml/min | |
| Rel. humidity | | | | |
| VOC | 51.8 | (3 d) | 52.4% | (28 d) |
| Aldehyde | 51.8 | (4 d) | 51.8 | (27 d) |
| Temp | | | | |
| VOC | 23.3 | (3 d) | 23.4°C | (28 d) |
| Aldehyde | 23.3 | (4 d) | 23.3 | (27 d) |

The results of the FLEC test are presented in Table 5, wherein it is apparent that the TVOC value of the linoleum layer without a coating is highest at 170 μg/m²·h. This value is slightly higher than that of a PUR-coated linoleum layer.

Examples 2 and 3, which contain no photoinitiators in the coating, have a lower TVOC value compared to the uncoated linoleum layer. However, although they contain no photoinitiators, examples 2 and 3 have distinctly higher TVOC values than examples 4 to 7 according to the invention.

TABLE 5

| | TVOC Measurement |
|---|---|
| Example | after 28 days [μg/m² · h] |
| 1 | 170 |
| 2 | 52 |
| 3 | 74 |
| 4 | 27 |
| 5 | 13 |
| 6 | 8 |
| 7 | 5 |

### Example 4

Coating Compositions 8 through 13 are prepared according to the formulations set forth in Table 6 where all amounts are in weight percentage. The compositions are prepared by first mixing the resin components with any reactive diluents, amine synergists, surfactants and dispersing agents at room temperature under agitation. Thereafter, the photoinitiator is slowly added with agitation until all initiator is dissolved. The photoinitiator is added at room temperature or, in some cases, at 45° C. followed by returning to room temperature. Next, the flattening, i.e. matting, agents are added, except for any flattening agents already present in a self-matting resin. The flattening agents are slowly added to the formulation during agitation, followed by at least an additional 5 minutes of mixing. The formulations are discharged to brown glass jars for storage at room temperature.

TABLE 6

| | Composition # | | | | | |
|---|---|---|---|---|---|---|
| | 8 | 9 | 10 | 11 | 12 | 13 |
| Ingredient | Wt. % | | | | | |
| Acrylate component | 82.6 | 82 | 82 | 82 | 82 | 76.1 |
| Amine synergist | 2.5 | 2.5 | 2.5 | 2.5 | 2.5 | 2.4 |
| Surfactant | 0.7 | 0.7 | 0.7 | 0.7 | 0.7 | 0.6 |
| Photoinitiator | 3.3 | 3.3 | 3.3 | 3.3 | 3.3 | 3.1 |
| Flattening agent | 6.3 | 7 | 7 | 7 | 7 | 13.7 |
| Abrasive | 4.1 | 4.1 | 4.1 | 4.1 | 4.1 | 3.8 |
| Acrylic block copolymer | 0.5 | 0.4 | 0.4 | 0.4 | 0.4 | 0.3 |
| (Disperbyk 2008) | | | | | | |

### Example 5

Substrates possessing a wear layer produced according to methods of the present invention are compared to substrates possessing a wear layer produced according to conventional methods, for iodine stain resistance. Stain resistance is measured by placing iodine on an area of the coated flooring. After a period of time, the area is cleaned with isopropyl alcohol. Color readings of the area are taken before and after the test. A Δb value for each sample is reported. The results are shown in Tables 7 and 8 (below). These results demonstrate that substrates coated by exemplary methods of the present invention provide an unexpected level of resistance to scratches and iodine staining.

TABLE 7

| | Comp. Ex. 1* | Coating #9 |
|---|---|---|
| 1 min iodine Δb | 30.43 | 12.6 |

*Comp. Ex. 1 is a commercially available acrylate-based coating which was cured using a standard arc lamp curing method.

TABLE 8

| | Comp. Ex. 11** | Coating #13 |
|---|---|---|
| Scratch Test (% retained) | 70. 1 | 100 |

**Comp. Ex. II is a coating having the same composition as Coating #13, but which was cured using a standard arc lamp method.

It is intended that any patents, patent applications or printed publications, including books, mentioned in this patent document be hereby incorporated by reference in their entirety.

As those skilled in the art will appreciate, numerous changes and modifications may be made to the embodiments described herein, without departing from the spirit of the invention. It is intended that all such variations fall within the scope of the invention.

1. A sheet material comprising:
at least one base layer comprising linoleum or korkment; and
a (meth)acrylate-based coating arranged thereon;
wherein the sheet material has a TVOC (total volatile organic compounds) value of ≦50 μg/m²·h, measured according to ISO 16000-10 by means of a field and laboratory emission cell (FLEC).

2. The sheet material according to claim 1, in which the (meth)acrylate-based coating is cured by irradiation using a source of high-energy photons in combination with a UV radiator.

3. The sheet material according to claim 1, wherein the concentration of a photoinitiator that is used in the uncured (meth)acrylate-based coating is 0.01 to 5% by weight, relative to the total mass of solids of the coating.

4.-6. (canceled)

7. The sheet material according to claim 1, wherein the base layer is provided on a substrate.

8. The sheet material according to claim 1, having a gloss level of 10 to 15 according to DIN 67530 at 60°.

9. The sheet material according to claim 1, wherein the total acceptance angle according to DIN 51130 is at least 6° and no more than 10°.

10. The sheet material according to any one of claim 1, wherein the (meth)acrylate-based coating is transparent and a further design-creating layer is arranged between the (meth)acrylate-based coating and the base layer.

11.-12. (canceled)

13. The sheet material according to claim 1, wherein the (meth)acrylate-based coating and/or a layer beneath comprises an embossing.

14.-18. (canceled)

19. A method for producing a wear layer on a substrate comprising:
applying a radiation curable composition comprising a (meth)acrylate component to a surface of a substrate, the substrate comprising linoleum or korkment; and
irradiating the substrate to which said composition has been applied with a source of radiation having a wavelength from 10 nm to 200 nm, to form a wear layer.

20. The method of claim 19, further comprising the step of precuring the radiation curable composition prior to the step of applying said composition to the substrate with a source of radiation having a wavelength of from 10 nm to 200 nm, wherein the pre-curing is carried out at a temperature of from about 110° F. to about 125° F.

21. (canceled)

22. The method of claim 19, further comprising the step of heating said substrate to a temperature of from about 77° F. to about 140° F. prior to irradiating said composition.

23. (canceled)

24. The method of claim 19, wherein the composition further comprises an abrasive.

25. The method of claim 19, wherein the wear layer is produced in the presence of nitrogen flowed at a nitrogen flow rate of about 40 Nm³/hour.

26. The method of claim 19, wherein the coated substrate is irradiated in an environment having an oxygen concentration of from about 10 to about 200 ppm per square meter of material surface.

27. (canceled)

28. The method of claim 19, wherein the coated substrate is irradiated at a line speed of from about 1 m/min to about 10 m/min.

29.-30. (canceled)

31. The method of claim 19, wherein the composition comprises from about 65 wt. % to about 95 wt. % of an acrylate component selected from polyester acrylate; urethane acrylate; epoxy acrylate; silicone acrylate; and a combination of two or more thereof.

32. (canceled)

33. The method of claim 19, wherein the source of radiation used to irradiate the substrate to which said composition has been applied, comprises an excimer lamp operated at a power setting that is about 50% to about 80% of maximum power output.

34.-36. (canceled)

37. The method of claim 19, wherein the substrate to which the coating has been applied is irradiated for a time and intensity sufficient to provide a total energy density of about 1 J/cm².

38. The method of claim 37, wherein the substrate to which the coating has been applied is irradiated a plurality of times and the substrate to which the coating has been applied is irradiated with at least one of UVA, UVB, UVC, or VUV radiation.

39.-41. (canceled)

42. The method of claim 19, wherein the radiation curable composition is applied to the substrate in an amount sufficient to provide a coating having a density of from about 1 g/m² to about 3 g/m².

43. (canceled)
